(19) United States
(12) Patent Application Publication
(10) Pub. No.: US 2002/0134891 A1
(43) Pub. Date: Sep. 26, 2002

(54) Ejector pump flow control

(76) Inventors: Stephen A. Guillot, Blacksburg, VA (US); Wing Fai Ng, Blacksburg, VA (US)

Correspondence Address: James W. Hiney, Esq., Suite 1100, 1872 Pratt Drive, Blacksburg, VA, 24060, US

(21) Appl. No.: 09/781,590

(22) Filed: Feb. 9, 2001

(51) Int. Cl. B64C 23/06

(52) U.S. Cl. 244/199

(57) ABSTRACT

A boundary layer control mechanism for use in diffusors, aircraft wings, propellers, rotors, stators and casings comprising a suction means for applying a suction to a flow which is commencing to become turbulent, a blowing means for applying a blowing to the flow commencing to become turbulent and wherein said blowing means creates said suction means and they act in concert with a control means to affect boundary layer control

This invention relates to the use of ejector pumps for flow control over aerodynamic surfaces including axial compressors and inlets. It also covers ejectors in stators and rotors. Specifically the invention is used to create suction on and blowing for control of boundary layers but the invention may be used elsewhere including with stators and a closely coupled rotor.

In general, the invention is concerned with the application of ejector pumps as flow control devices. Specifically, the technology may be applied to inlets and axial compressors of gas turbines but the flow control may also be applied to any situation where flow separation may be a problem including diffusers, aircraft wings, propellers, automobiles and watercraft such as submarines and ships.

### BACKGROUND

A major limitation in advancing the state-of-the-art in gas turbine compression systems is flow breakdown in stator vanes due to overly aggressive diffusions. The instant invention concerns itself with a new revolutionary gas turbine stator that employs miniature ejector pumps for flow control Ejector pumps embedded in the stator vanes are the enabling technology that makes simultaneous suction and blowing feasible. An ejector pump uses high-pressure air bled from the compressor to create suction through the venturi effect. The mixed stream of suction flow and high-pressure air can then be used for boundary layer control and trailing-edge blowing to reduce the size of the wake.

Coupled with an ultra-highly-loaded rotor, the smart stator technology has the potential to reduce the number of compression stages in a turbine engine by one-third, significantly reducing the size, weight, and complexity of the engine. In addition, flow control of the stator can drastically reduce high-cycle fatigue problems.

The efficiency of highly-loaded compressor stages has been of considerable demand over the last 20 years (Coperhaver, W. W., et al 1993, Puterbuagh, et al. 1997) The recent development of highly-loaded fan and rotor stages has put a severe constraint on the performance of the stator blades. Boundary layer separation due to high blade loading can produce larger blades wakes, resulting in significant aerodynamic and aeromechanical interaction between stages as well as hindering the performance of the stator. While a fan-rotor with a pressure ratio of nearly 3 is possible technology, an efficient downstream stator that can effectively diffuse and turn the flow at both design and off-design conditions remains a major hurdle for designers. The use of flow control on the stator blades will allow ultra-high-turning stator vanes to be used. Thus, for design and off-design conditions of the compressor stage, the flow control stator, coupled with an aggressively designed rotor, has the potential of revolutionizing the compression system.

The instant inventors employ blade-embedded, miniature ejector pumps for flow control on the stator. An ejector pump uses high pressure air (from the engine core compressor ) to create a suction using the venturi effect. The mixed stream of suction flow and high-pressure air can then be used for blowing to provide the boundary layer with the momentum necessary to resist separation in the adverse pressure gradient. This high-momentum fluid will then be able to fill in any remaining wake that is formed downstream of the stator. Furthermore, by mixing bleed air from the suction with the high-speed jet instead of dumping it overboard, the penalty of “bleed drag” associated with boundary layer suction is avoided.

Unlike other flow control actuators, ejector pumps do not require electrical power and do not have moving parts, making them intrinsically easier to implement and much more robust. Variability in the actuation of the flow control is achieved in two ways: actuation control and location. Varying the motive pressure supplied to the ejector pumps can control the suction mass flowrate and blowing momentum. By using arrays of ejector pumps at different chordwise positions, the location of actuation can be controlled. This is essential for making the flow control system adaptive to changing flow conditions which result in different separation locations and thus different optimum locations for flow control.

The objective of the flow control system is to develop stators that will achieve an unprecedented stage pressure rise and loading in a compressor. To realize the maximum potential payoff, the stator will have to be coupled with an unconventional compressor rotor. Several configurations of this type of rotor are currently being researched. While it has been proven that rotors with pressure ratio from 3:1 to 5:1 are possible, it is doubtful that existing stators will be able to diffuse the flow adequately without flow control Thus this “ejector pump technology” will bridge that technology gap and allow a compressor state to be deployed that can achieve a stage pressure ratio twice the level of today's technology. Attaining this goal will dramatically reduce the part-count, production and maintenance costs, and increase the reliability of the compressor system. Additionally, reducing the stator wake significantly reduces the high-cycle fatigue problem in military gas turbine engines by eliminating the vertical forcing function on the downstream rotor.

The stators are integrated into the next generation military engines that incorporate the state-of-the-art high-pressure ratio rotor currently being researched by others. The internal ejector pump design for the stators is the culmination of the extensive experience the inventors have gained from using ejector pumps in other work. Hollow blade design is already a part of many modern fan, rotor, and stator blades for the purpose of weight savings. The “smart” stator takes advantage of this fact and uses the internal cavity as a high-pressure plenum to supply the ejectors. These plenums will be supplied with high-pressure air from the downstream compressor stages in much the same way that cooling air is supplied to turbine blades for film cooling.

Most high-speed aircraft inlets diffuse the air before it reaches the engine and therefore have an adverse pressure gradient which can potentially lead to flow separation. Therefore any inlet is a potential application for the flow control concept. New serpentine inlets (designed to hide the engine for stealth reasons ) are particularly susceptible to flow separation which creates an undesirable entrance flow for the engine. The objective of this invention is to reduce the separated flow in these types of inlets and reduce the “fan face distortion”.

### BACKGROUND ART

There have been several studies done dealing with engine face distortion which is a problem for inlet designers. Williams and Surber (1993) pointed out that the inlet must be robustly designed to ingest the boundary layer formed by the aircraft fuselage and the vortices created by an upstream source such as a wing, while minimizing separation and secondary flow within the inlet itself Ball (1984) showed that the shape of the entrance boundary layer profile has a strong influence on the total pressure recovery and distortion at the exit. Anderson and Gibb (1998) warn that an inlet designer must be able to account for a wide range of flight conditions and maneuvers. For example, extreme angles of attack tend to separate the flow at the cowl lip, and extreme aircraft acceleration can generate secondary flow within the inlet.

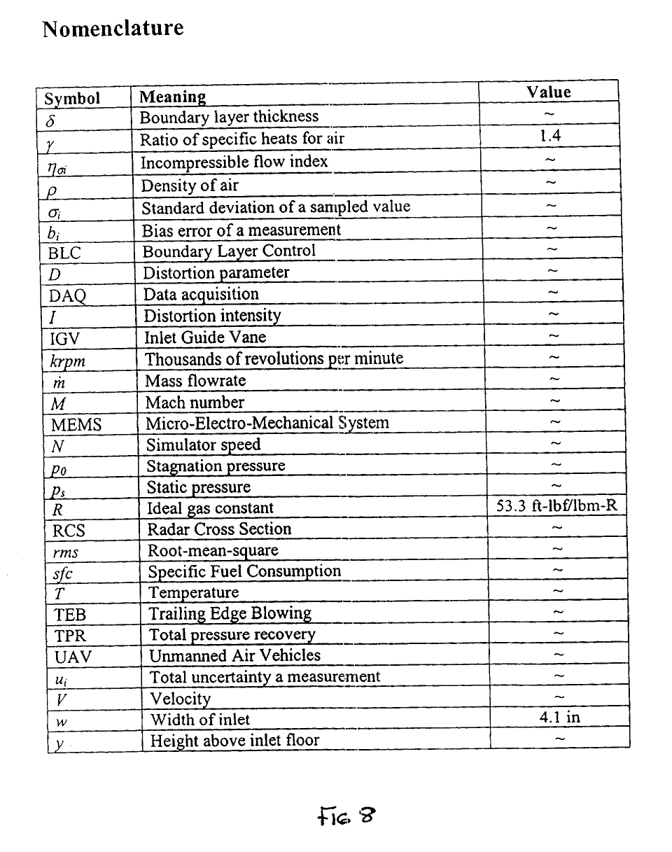

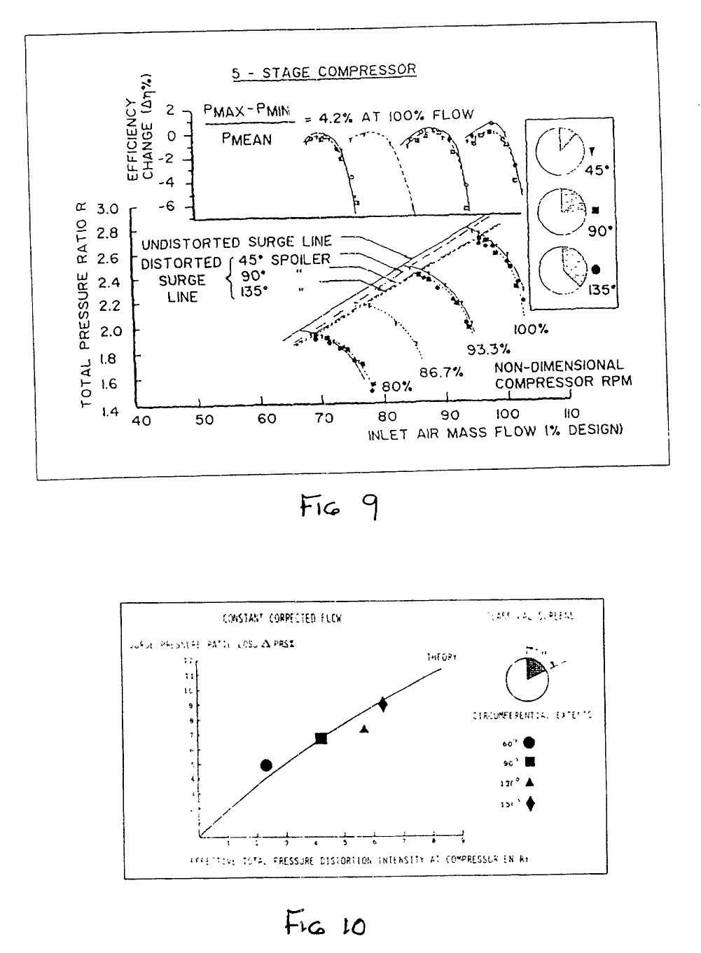

A non-uniform total pressure profile reaching the engine face has many adverse effects on the engine's characteristics. FIG. 9 shows how the surge margin decreases as the level of circumferential distortion increases. Note that when the circumferential distortion goes above the critical angle of 90 degrees the surge line changes very little. The figure also shows that a loss of efficiency is created by distortion. FIG. 10 shows the surge pressure ratio's sensitivity to distortion (Williams and Surber 1993). Due to curvature, even essentially isentropic serpentine inlets can have a non-uniform static pressure distribution at the exit of the inlet which Williams (1986) claims to directly affect an engine's thrust as shown in FIG. 11. Williams and Surber (1993) explain that it is difficult to correlate distortion with performance since the response to the whole system must be determined, but they mention that distortion can hinder the performance of variable geometry features like tandem stators by creating misalignments with flow sensors. They also show that compressor surge is much more sensitive to distortion than performance quantities such as thrust, specific fuel consumption and air mass flow.

Leitch (1997), Rao (1999) and Feng (2000) used trailing edge blowing (TEB) on an inlet guide vane (IGV) to minimize the distortion responsible for a periodic loading of the first compressor rotor. All three used the same test facilities, which included a small turbofan simulator with a constant-area inlet with four flat IGVs. Leitch showed that wake management had an effect by reducing circumferential distortion by 22.4%, the engine tones by 8.9 dB, and the overall SPL by 1.0 dB. Rao introduced active flow control to the TEB system Leitch proposed and lowered engine tones by as much as 8.2 dB, and reduced the sound power by as much as 64%. Feng replaced the pitot-Static tubes used by Rao with non-intrusive microphones which empower active flow control to become an efficient means to manage wake deficits.

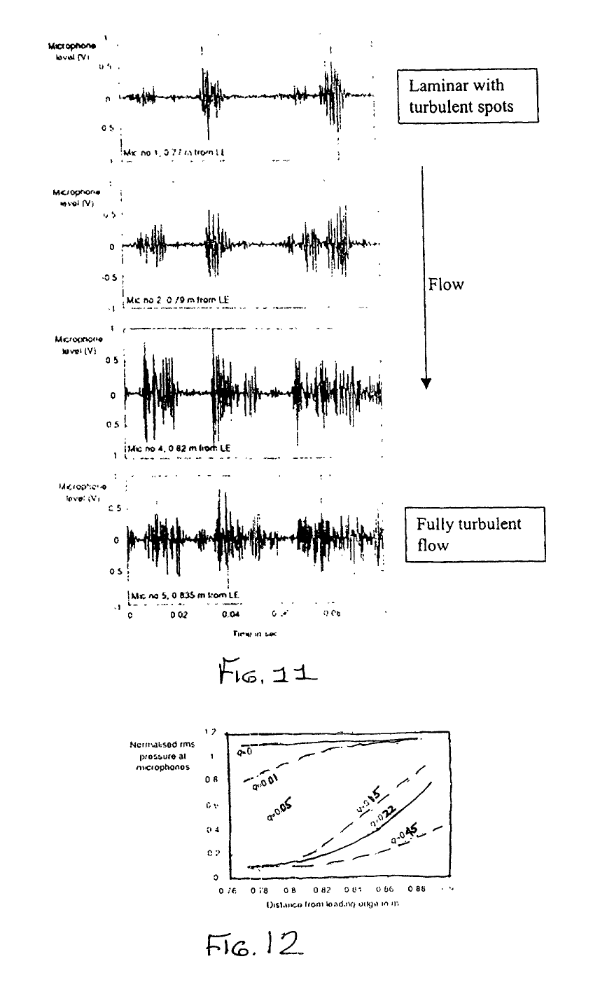

Rioual et al (1994) demonstrated active flow control to delay the laminar to turbulent transition of a boundary layer using a suction panel on a flat plate in a wind tunnel. An array of microphones downstream of the suction panel measured pressure fluctuations as the boundary layer grew turbulent. FIG. 11 shows the development of turbulent spots that spread into a full-blown turbulent boundary layer as the distance from the leading edge is increased. Each microphone signal was conditioned and then sent to a controller for a centrifugal pump to control the suction flowrate. FIG. 12 shows the root-mean-square (rms) pressure decreases as the suction flowrate increases. It also shows that as the boundary layer grows from the leading edge, the microphone sees a higher rms pressure. Rioual et al measured the rms pressure of each microphone corresponding to the desired transition point and then programmed the controller to match the microphone signals by varying the suction flowrate.

Vane type vortex generators are commonly used to control separation in inlets by locally mixing the low-momentum part of the fluid with the high-momentum part. There has been limited success for these vortex generators in serpentine ducts due to their lack of adapting to off-design flight conditions.

B. H. Anderson et al (1999) attempted to globally control the inlet flow conditions with small vortex generators ideal for compact inlets and MEM-actuated active control schemes. Their approach is not to prevent separation but to mix the low and high-momentum parts of the fluid to maximize pressure recovery and minimize distortion. They suggest that vortex flow control is not just a function of how the velocity is formed, but the overall vorticity strength and distribution to maximize mixing. The concept has sparked a transition from finding the right wave geometry to finding the right vorticity signature that will be effective on a large range of inlet conditions.

Ball (1983) of Boeing performed several experiments in the mid-1980s to show the effects of another type of flow control in serpentine inlets, namely wall suction and blowing. He used a three dimensional serpentine diffuser with area suction and slow blowing and found that with a suction flowrate of 6% of the core flow the total pressure recovery improved by 1.23%. Independently, he also found that with 3.5% blowing the total pressure recovery improved by 1.64%. Suction and blowing are seen to improve the total pressure ratio profile at the exit of the inlet. He did not, however, combine suction and blowing to determine that the benefit that both may provide in improving total pressure recovery, distortion or exit profiles. Ball later optimized his blowing scheme by adding different types of blowing jets, discrete tangential jets, slanted holes, vortex generators, and jets aimed at the diffuser corners. He also examined the benefits of directing the jets toward the corners of the walls. He found that discrete jets provided the best configuration at only 0.06% blowing. He found an optimum blowing rate which he speculated to be where the static pressure of the jet matches the wall's local static pressure and therefore the mixing is most efficient. He did not optimize the locations of the blowing holes nor did he perform any parametric study with boundary layer suction.

Agarwal and Simpson (1989) showed that microphones in a stream of fluid create a signal with several components. A microphone signal represents acoustic pressure, turbulent pressure fluctuations and wall vibrations. The acoustic wall equation does not govern the turbulent pressure fluctuations and wall vibrations. The turbulent pressure component is derived from a set of microphone signals. Lighthill (1951) explored the acoustic pressure component and is one of the pioneers in developing a base of knowledge on aeroacoustics. His famous theory models the fluctuating density within an arbitrary fluid motion as a sound propagating through a uniform fluid at rest subject to fluctuating external force field. He went on to show that the physical mechanism for the generation of aerodynamic noise is the fluctuating Reynolds-type stresses associated with turbulence. Since the shearing stresses create a positive displacement in one diagonal direction of the fluid particle and a negative displacement in the other, the sound behaves like an acoustic quadrapole that becomes stronger as the Mach number increases.

In addition to the acoustic noise created by fluctuating turbulent stresses that Lighthill studied, turbulent pressure fluctuations are another component to a microphone signal within a flow. Pressure fluctuations that exist under turbulent boundary layers or within shear layers are caused by eddies and vortices impinging on the microphone diaphragm and are not therefore governed by the acoustic wave equation. Turbulent pressure is sometimes referred to as “pseudo noise” because it may be detected as an acoustic pressure wave, but is actually the varying, instantaneous static pressure within a turbulent flow. The wave speed of the turbulent pressure fluctuation is not the speed of sound but simply the convecting speed of the eddy or vortex that creates it. The pressure fluctuations are generally low-frequency and may peak at a normalized frequency of about 0.2. At lower frequencies, the turbulent pressure fluctuations are affected by extraneous noises but at higher frequencies the pressure fluctuations may cancel due to the large size of the microphone compared to the wavelength of the fluctuation. The magnitude of the pressure fluctuations tends to fall with an inverse power of the frequency. Turbulent pressure fluctuations are related to turbulence levels which are generally created by wall shear stresses so minimizing drag will tend to minimize the turbulent pressure fluctuations.

Measuring pressure fluctuations have increased the understanding of turbulent boundary layers. Relying on the premise that acoustic pressure and turbulent pressure are incoherent and that acoustic waves are known to be planar below the duct cutoff frequency two methodologies have been proposed.

In 1987 Simpson et al proposed a method to discriminate turbulent pressure from acoustic pressure by separating two microphones in the spanwise direction by at least ½ of the boundary layer thickness which is said to be greater than the largest local vortex It assumes that the mean-square of the two turbulent pressure components of the microphones are equal but their cross-correlation is zero since the vortices that create them have the same magnitude but are not in phase. Since the acoustic pressure is the same everywhere, they are able to resolve the true turbulent component by the following equation.

$$\overline{{p}_{Tn}^{2}} = \frac{1}{2} \overline{{( {p}_{1 n} - {p}_{2 n} )}^{2}}$$

where

p_{Tn} is the turbulent pressure at spectral frequency n

p₁ₙ is the first microphone signal at spectral frequency n

p₂ₙ is the second microphone signal it spectral frequency n

\overline{( )²} represents the mean of the square of ( )

In 1989 Agarway and Simpson were able to refine the previous method by allowing the microphones to be closer together but introducing a time delay, r, in one of the microphone signals. Since the randomly distributed turbulent pressure component of the delayed microphone signal is uncorrelated with that of the other microphones, the following equation can find the turbulent pressure for frequencies 1/r and its higher harmonics.

$$\overline{{{p}_{1} ( t )}^{2}} = \frac{1}{2} \overline{{[ {p}_{1} ( t ) - {p}_{2} ( t + τ ) ]}^{2}}$$

where

pₜ(t) is the turbulent pressure at time t

p₁(t) is the microphone signal at time t

p₂(t) is the second microphone signal at time t+τ

\overline{( )²} represents the mean of the square of ( )

The earliest flow control experiments involved the use of boundary layer suction to increase the lift of airfoils. Poisson-Quinton and Lepage (1961) and Williams (1961) provided summaries of various boundary layer suction studies performed in the 1940's and 1950's. These results showed that by increasing boundary layer suction at the deflected airfoil flaps produced a constant increase in the lift of the airfoil until the flow was completely attached More recent experiments by Wyganski (1997) compared steady flap blowing to oscillatory flap blowing.

The first study to use stator trailing edge blowing (TEB) parallel to the flow field with the purpose of reducing the stator wake, was performed by Park and Cimbia (1991) on a flat plate in a low speed wind tunnel. This two dimensional momentum wake was determined to be strongly dependent on the TEB configuaration. Nauman (1992) also investigated these TEB hold configuration, with the addition of double discrete jets, on a fully turbulent flat plate in a low speed continuous water tunnel.

The effectiveness of flow control in gas turbines was investigated by Kozak and Ng (2000) using an inlet guide vane experiment in an Allied Signal F109 turbofan engine. Measurements were performed downstream of the IGV at the locations of practical stator/rotor spacing. The results showed near complete waking filling in the span and pitchwise directions at axial distances between 0.1 and 0.25 IGV chords downstream and complete wake filling at further axial locations. A jet velocity of approximately 1.5 times the free stream velocity was required for complete wake attenuation. Remarkably, the mass flow required for complete wake filling was measured to be only 0.035 of the engine inlet mass flow for each IGV.

Recent turbomachinery boundary layer suction studies have been performed for the Massachusetts Institute of Technology aspirating rotor test rig program. Kerrebrock (1998) performed numerical design studies for a family of fan stages of varying tip speeds that use boundary layer suction. Calculations showed that for separated flow the reduction in momentum thickness is exponentially related to the distance downstream from the point of suction application. This indicated that a large amount of control over the downstream boundary layer thickness could be achieved with a small amount of mass removal.

Waitz (1995) performed both numerical and experimental investigations of a high-bypass ratio fan blade design in a low speed cascade tunnel. Sell (1997) performed a more comprehensive experimental investigation based on the Waitz study. Bons (1999) applied a blowing technique for separation control on the middle blade of a cascade of eight Pratt and Whitney PakB blades, which are a scaled version of a typical highly-loaded low-pressure turbine blade. Each study showed that the presence of the pressure side boundary layer and the finite thickness of the trailing edge limited the reductions in wake width and deficit that could be achieved by suction.

The first study to implement simultaneous trailing edge blowing and boundary layer suction was performed at Virginia Tech by Vandeputte (2000). The cascade experiments were performed on large wake producing tandem IGV with a flap deflection angle of 40 degrees. The application of boundary layer suction reduced the baseline pressure loss coefficient and wake momentum thickness by 20%. This was achieved with a suction mass flow of 0.4% of the passage flow. The simulataneous addition of trailing edge blowing resulted in an overall reduction of 40% of the wake momentum thickness.

Referring to prior U.S. patents that employ some of the work just discussed by the various predecessors in the field, we see that the work of Lurz, in U.S. Pat. No. 4,664,345, where he used suction inlets in the surfaces of wings just upstream of where the boundary layer transits into turbulent flow and blowing outlets just downstream of the disturbance with a flow channel connecting the inlet and outlet. He assures passage of the flowing medium through these channels due to a pressure differential there between.

Haslund, in U.S. Pat. No. 4,671,474, shows the use of a plurality of slots in a stream of fluid and combining them with suction generating means to generate vortex flow patterns in each slot.

In U.S. Pat. No. 5,222,698, there is shown the use of sucking air from a surface to reduce turbulence in the boundary layer of a flow of air across the surface. A plurality of detectors are provided in the surface downstream of apertures in the surface. The inventors, Nelson et al, arrange their suction means so as to sequentially expose them to the fluid flow downstream to eliminate fluid flow.

The patent to Bennett et al, U.S. Pat. No. 4,736,913, shows a fluid flow control device for controlling turbulence along the surface of an aircraft fuselage by blowing fluid into the stream of flow.

U. S. Pat. No. 5,374,013 shows a method and apparatus for reducing drag on a moving body. It describes outletting inlet air at the rear of an aircraft engine by a plurality of small high-energy vortices and a pressure shell at the rear of the engine.

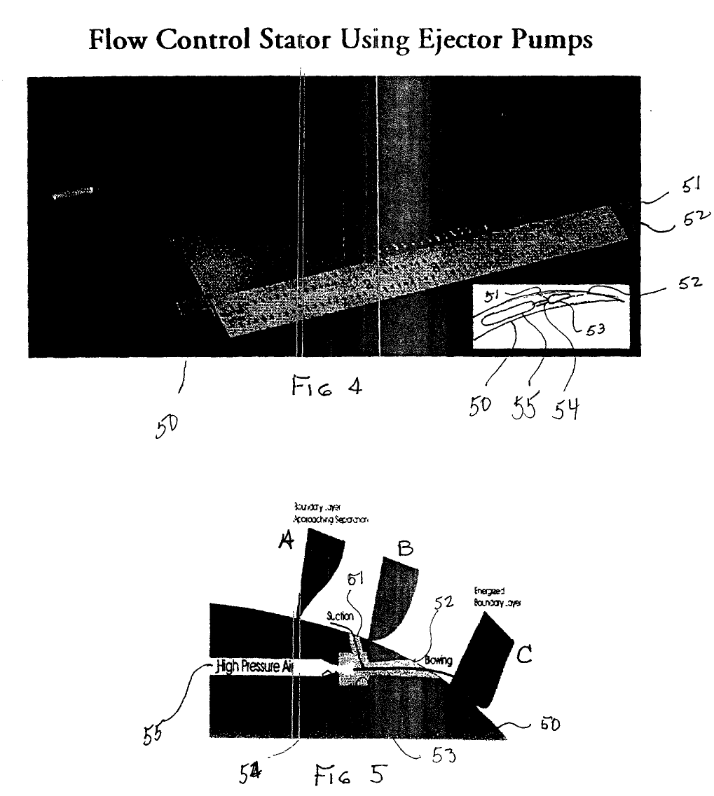

U.S. Pat. No. 5,407,245 shows the use of blowing and sucking to reduce drag of turbulence on a rear auto panel. FIG. 4 shows the blowing taking place at 9 and the suction occurring through apertures 10.

The patent to Savitsky, et al, U.S. Pat. No. 5,417,391, shows the use of suction to control boundary layer turbulence on a rear airfoil by providing vortex chambers within the rear airfoil surface. Likewise, the patent to Meister et al, U. S. No. 5,899,416, shows the use of suction applied to boundary layer control in the leading edge of the rudder assembly. The patent mentions blowing only in the sense of providing a de-icing mode to the assembly.

U.S. Pat. No. 6,027,305 shows the use of blowing pressurized air into the flow stream to control turbulence in a stator.

U. S. Patent No. 6,079,671, shows the use of an outer porous skin region in the outer surface of an airfoil which is used to bleed flow into a plenum chamber with a control means to adjust the precluding of air flow to the chamber to reduce turbulence.

Gazdzinski shows, in U.S. Pat. No. 6,068,328, the use of detectors, a controller and suction to be used in conjunction with perforations to control turbulence in a vehicle boundary layer.

### GENERAL DESCRIPTION

In current military aircraft, the emphasis is on maintaining a low radar cross section (RCS) that is difficult to detect. Many methods have been developed and proven for minimizing the RCS of the fuselage and wings of an aircraft, but the large metal blades within the engine's compressor easily reflect the radar energy striking it, which drastically increases the RCS of the entire aircraft. Hiding the face of the engine from the incoming radar signal is the best way to keep the RCS at a minimum. Consequently, a curved engine intake, known as a “serpentine inlet” is installed to scoop air from the free-stream while the engine is blended into the stealth like fuselage. The serpentine inlet diminishes the line-of-sight to the engine so that hostile radar cannot detect the metal surfaces of the blades.

To remove the line-of-sight blades while also minimizing the weight of the inlet requires the development of compact and highly-offset diffusers. The curve in the inlet poses problems, however, to an engine designer because of the distortion created by the flow separation. The inlet must possess enough of an offset to hide the fan-face from enemy radar, but Fox and Kline (1962) suggest that if the curved offset is too severe, the inlet will stall and develop flow separation to produce high levels of pressure distortion. A distorted total pressure profile entering the fan face has many drawbacks, but the most critical is the loss of stability. (Williams and Surber, 1993). The pockets of air with low-mean velocity may trigger rotating stall for the compressor fan, which decreases its efficiency, but if the distortion is severe enough, the rotating stall will progress into surge, which will fatique the engine's components.

To combat the flow distortion and separation in a serpentine inlet, one can add an extension to the inlet to allow the flow to reattach and the distortion to attenuate (Williams 1986) or the designer can install a set of vane-type vortex generators to thoroughly mix the low-momentum with the high-momentum regions of the fluid (Anderson et al. 1999). Both options claim some success but involve adding weight and manufacturing expense to any aircraft being treated and are generally not adaptable to operating conditions. Boundary layer control (BLC), is a new option made available to the designer by this invention. For any given inlet, BLC will minimize distortion without the extra weight of an extension or vanes. BLC treats the low-momentum fluid within the boundary layer that promotes separation. BLC can take the form of suction, blowing or a combination of both. While suction attempts to remove the low-momentum fluid, blowing attempts to re-energize the low-momentum fluid for it to negotiate the strong adverse pressure gradients and remain the low-momentum fluid for it to negotiate the strong adverse pressure gradients and remain attached to the inlet wall.

While the weight or complexity of the conventional ejector pumps may have hindered boundary layer suction in the past, vacuum ejector pumps provide a lightweight and small scale, and inexpensive solution without moving parts. Long lossy suction lines can be avoided, since ejector pumps can be integrated into the inlet and use high-pressure air from the engine's compressor to provide the vacuum. Furthermore, the exhaust of an ejector pump has the potential to provide the boundary layer blowing, allowing a combined BLC effort for approximately the same amount of bleed from the latter stages of the compressor.

Tactical aircraft must fly in a large number of maneuvers, which adds to the difficulty in minimizing the distortion. Consequently, active flow control keeps a serpentine inlet efficient through a larger range of conditions. Unfortunately, the implementation of active flow control in a serpentine inlet has been hampered by the lack of practical means to sense the effectiveness of the BLC.

Rioual et al (1994) discovered that a microphone, mounted flush with the surface, could sense where the boundary layer transitions on a flat plate. The non-intrusive sensor showed that the pressure signal increased as the boundary layer grew turbulent. Rioual used this discovery to actively control where the transition occurred with boundary layer suction. Also, Simpson et al (1987) showed that turbulent pressure fluctuations, measured by microphones, in a separating flow, normalized by the turbulent shear stress, increases to the point of detachment but decreases after detachment. The information provided by Rioual et al and Simpson et al shows a strong correlation between a flow structure and a microphone signal that can be used for an active BLC scheme.

The work presented in this document attempts to examine the benefits of BLC in a 2-D serpentine inlet in front of a 1/14 scale turbofan simulator. Ejector pumps were used as the source for the boundary layer suction. The exhaust of current ejector pumps is not suitable for boundary layer blowing so a regulated high-pressure line is used. Both aerodynamic and microphone experiments were performed to examine the effects of BLC on the flow field. The aerodynamic data showed that distortion decreases and pressure recovery increases as the BLC effort is increased. The microphone experiments were an initial step in developing an active flow control scheme to minimize distortion. The results suggest that BLC effort is increased, the microphone signal decreases in amplitude within a low-frequency range.

Non-intrusive microphones were designed to correlate the effectiveness of BLC on the total pressure profile at the exit of the inlet. An array of ten microphones along the centerline was tested for its ability to detect the degree of separation. It was shown that the microphone correlated well with the aerodynamic data.

In stators, the spinning nature of the rotors in an axial compressor act to not only compress the air but also cause it to swirl about the axis of the compressor. The job of the stators is to turn the flow back to the axial direction and convert some of the kinetic energy generated by the rotors into back pressure. Much research has been performed to improve rotor design increasing the demand on the stators. The objective of flow control in this program is to create stators that turn the flow more aggressively (highly loaded stators ) and create a higher pressure rise. This tends to create a separation prone stator. The invention is designed to prevent this separation.

In a hub and casing the approach is to prevent the separation from the hub and casing that house the compressor.

To develop the instant inventive techniques, a quarter scale turbofan engine simulator was used to provide the flow through an inlet. Boundary layer suction blowing and a combination of both were used to minimize the inlet's flow separation While the effectiveness of the suction alone and the blowing alone were shown to be about equivalent, the effectiveness of their combined use was seen to provide a solution more than equal to either one by itself which was unexpected. With blowing and suction flowrates around 1% of the simulator's core flow, the inlet's distortion was lowered by 40.5% (from 1.55% to 0.922% ) while the pressure recovery was raised by 9.7% (from 87.2% to 95.6% ). With its reduction in distortion, boundary layer control was shown to allow the simulator to steadily operate in a range that would have otherwise been unstable. Minimizing the flow separation within the inlet was shown to directly relate to measurements from flush-mounted microphones along the inlet wall. As the exit distortion decreased the microphone spectrum also decreased in magnitude. The strong relationship between the aerodynamic profiles and the microphone signal showed that microphones may be used in an active flow control scheme where the boundary layer effort can be tailored for different engine operating conditions.

The instant invention was developed using a turbofan simulator which provided the flow through a serpentine inlet. The simulator provided a realistic flow regime that exists in an inlet attached to a bypass turbofan engine found on military aircraft. The simulator has the ability to operate on a wide range of rotational speeds to provide a variable inlet throat Mach number. It consisted of a single stage fan with 18 rotor blades and a single stage turbine with 29 blades. The turbine, coupled to the fan, is driven by high-pressure air and the fan drew in ambient air that bypasses the turbine. A magnetic pickup measured the rotational speed and two thermocouples measure the bearing temperatures for the fan and turbine.

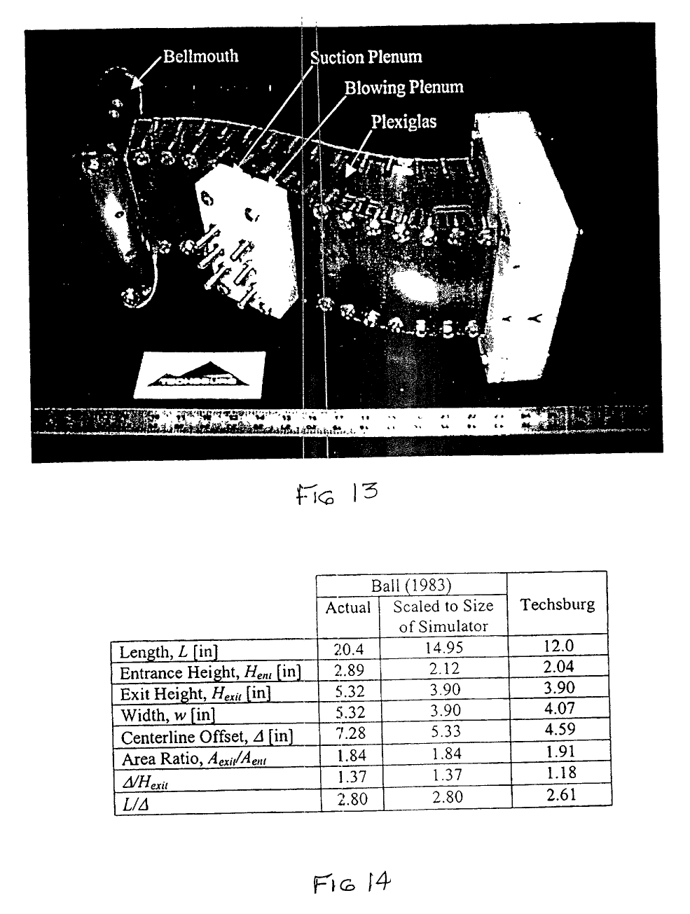

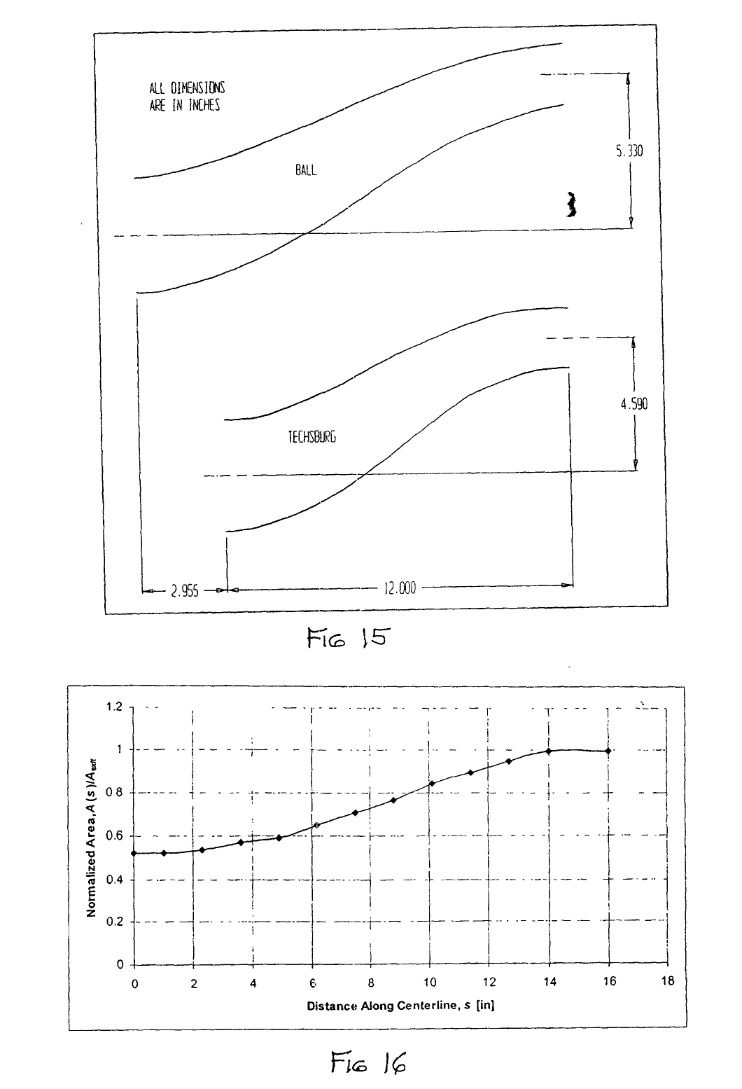

The geometry of the inlet was modeled so as to reflect that found on a modern stealthy tactical aircraft engine. It Was designed to maintain acceptable levels of distortion and pressure recovery while minimizing the radar signature of the engine by reducing the line of sight to the fan-blades. It was based on the geometry used by W. H. Ball (1983) at Boeing Military Aircraft Company. Ball used a two dimensional model as a working prototype. Since both three dimensional and two dimensional models give similar results, the inlet used herein was two dimensional. FIG. 13 shows a picture of the inlet with suction and blowing plenums. The table shown in FIG. 14 and in FIG. 15 compare the inlet of Ball with that of the instant invention. The instant inlet was also shortened by a factor of 0.80 to make it more compact and to show that BLC can be handled by shorter inlets. The shorter inlet, without BLC, promotes stall at lower Mach numbers. Like all inlets, the instant one suffered from separation because of two important factors, diffusion and curvature. The inlet diffuses the air to prevent shocks from forming on the rotating blades of the fan and the inlet curves to “hide” the fan-face from radar signals. The area distribution, showing the rate of diffusion of the instant inlet is shown in FIG. 16. The bellmouth was designed and installed onto the inlet to prevent separation at the entrance. For visual purposes, the inlet was made of ¾ Plexiglas and aluminum sheet.

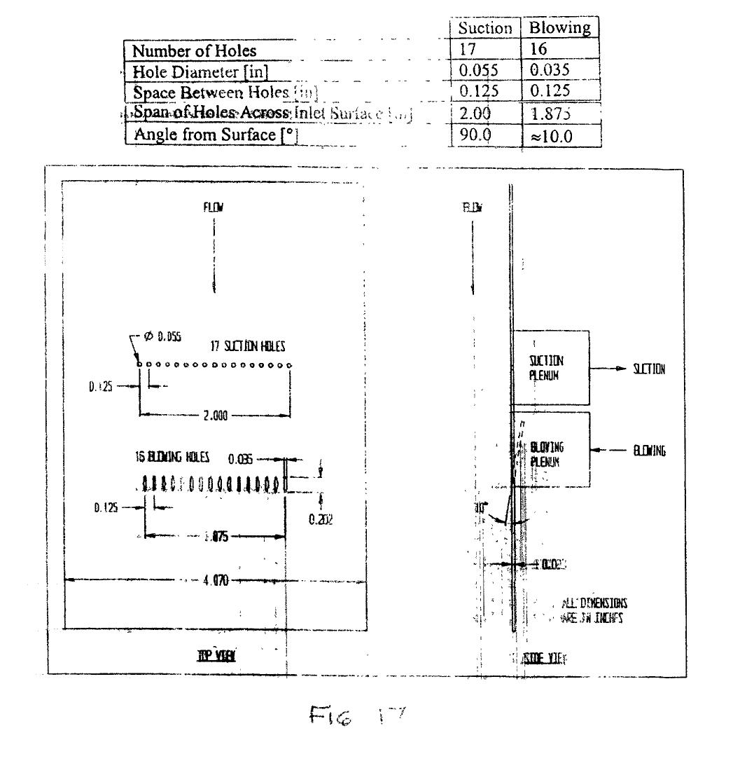

The suction and blowing holes had to be designed to effectively control the boundary layer. The number, position and orientation of the holes had to be determined Bench tests were performed to determine the separation point so that the suction holes could be placed just upstream of it. The high and low pressure plenums were placed directly on the inlet to provide a source for the blowing and suction holes. The plenums were intended to stagnate the air immediately next to the inlet so that the blowing or suction would be evenly distributed across all of the holes. FIG. 17 shows a drawing of the most effective configuration of the holes which were kept as large as possible to minimize losses.

The blowing holes were less critical than the suction holes as blowing has been shown to work with much design iteration. It was critical that the blowing holes be as tangential as mechanically possible to the surface to give the fluid an increase in momentum tangential to the inlet surface while giving it as little momentum as possible normal to the surface.

The ejector pumps provided the action for the boundary layer control. As is known, ejector pumps use high-pressure air to provide a region of low pressure. The high-pressure air is accelerated to high speed through a converging-diverging nozzle. When the high-pressure air diffuses, it entrains low-pressure flow behind it. The two streams form a mixed jet. An example of one is show in FIG. 18 and such pumps are ideal sources of suction for flow control since they are capable of large flow rates required to control high velocity flow. Changing the high-pressure supply and the exhaust backpressure can independently control the ejector pump. The ones used had a variable throat position to allow for added adjustment in setting the suction flowrate.

The flow within the inlet was characterized with the use of pressure probes. All Mach number measurements were taken at the entrance to the inlet with a Pitot-Static probe, measuring both total and static pressures. As such probes are only accurate when placed parallel to the flow to prevent the stagnation point moving away from the end of the probe.

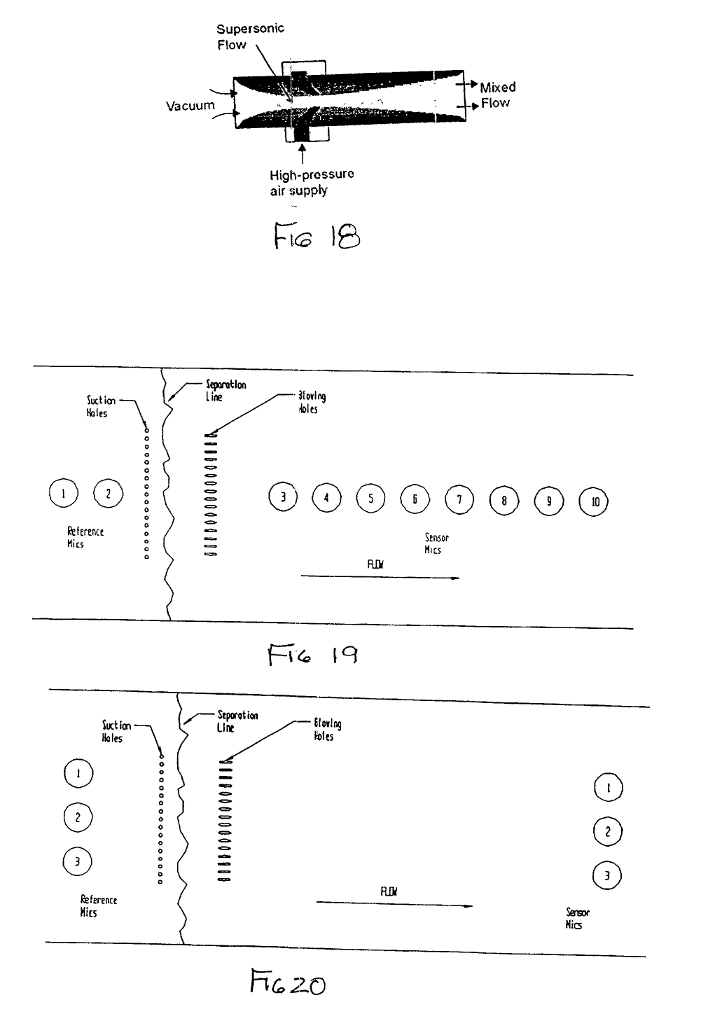

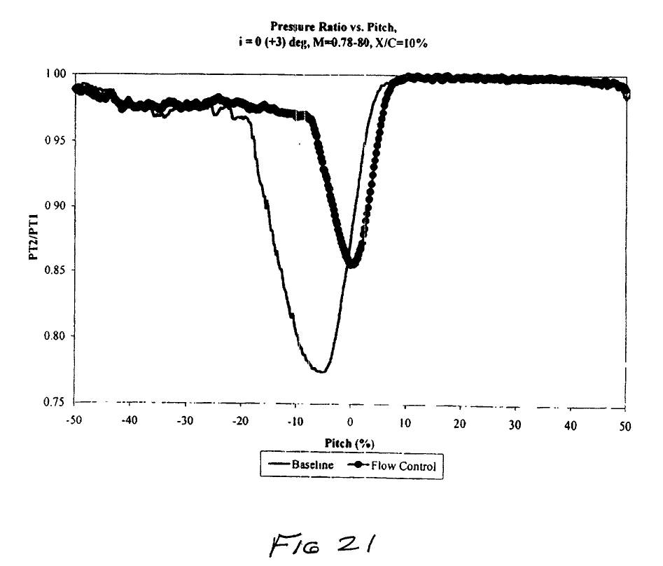

Rioual et al (1994) showed that microphones could be used to detect the transition from laminar to turbulent boundary layers and in this invention, the microphones were used to examine the difference between attached and separated flow. Active flow is made more practical by using microphones that can sense large-scale flow structures without disturbing the flow. The first configuration of microphones used was an array of ten microphones placed along the spanwise centerline of the bottom surface of the inlet. Two microphones were used near the entrance of the inlet to reference a well-behaved, attached boundary layer. Downstream of the separation point and blowing holes, eight more microphones were used to describe the flow as it separates. FIGS. 19 and 20 show the two configurations of microphones used, the first being already described and the second using two arrays of three microphones to resolve acoustic pressure fluctuations from turbulent pressure fluctuations. The first array was used as a reference to an attached flow and the second array at the exit of the inlet examined the effect separation and BLC have.

The suction and blowing flowrates were monitored to keep everything within a practical range. Typically, 1% is the maximum percentage of the core flow that could be available for flow control in any physical application. The source of high pressure air on aircraft is the latter stages of the compressor where a lot of work has been added to the air so the use of compressed air has a large potential to affect the performance and efficiency of the engine. BLC may improve performance and efficiency, but bleeding too much compressed air can limit performance of an engine.

Accordingly, it is an object of this invention to provide a boundary layer control method and configuration that will result in decreased loss coefficient,

It is another object of this invention to provide a boundary layer control method and configuration that will result in greater flow turning,

It is yet another object of this invention to provide a boundary layer control method and configuration that results in shorter chord length,

Another object of this invention is to provide an improved boundary layer control for stators which will result in increased pitch and fewer stators per stage,

Yet another object of this invention is to provide ejector pumps embedded in the stator vanes of a turbine to make simultaneous blowing and suction feasible for flow control,

Still another object of this invention is to provide an improved boundary layer control method and configuration for stators and rotors in jet engines resulting in a reduced wake and less high cycle fatigue on the downstream rotor and reduced noise, and

A further object of this invention is to provide an improved boundary layer control method and configuration for jet engines resulting in increased stall margin.

Another object of this invention is to provide ejector pumps as flow control devices.

These and other objects will become apparent when reference is had to the accompanying drawings in which:

### DETAILED DESCRIPTION

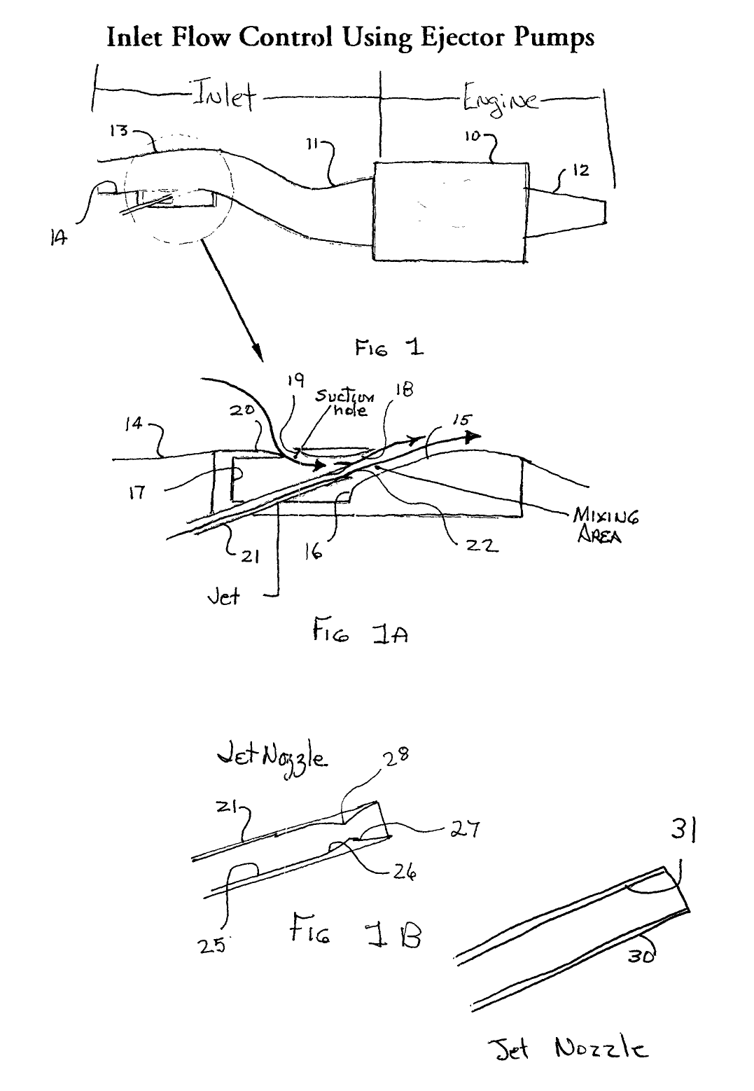

FIG. 1 is a schematic view of the application of the invention for inlet flow control using ejector pumps,

FIG. 1A is an enlarged section of a portion of FIG. 1 showing the flow control details,

FIG. 1B is an enlarged section of a portion of FIG. 1A showing the configuration of the suction device,

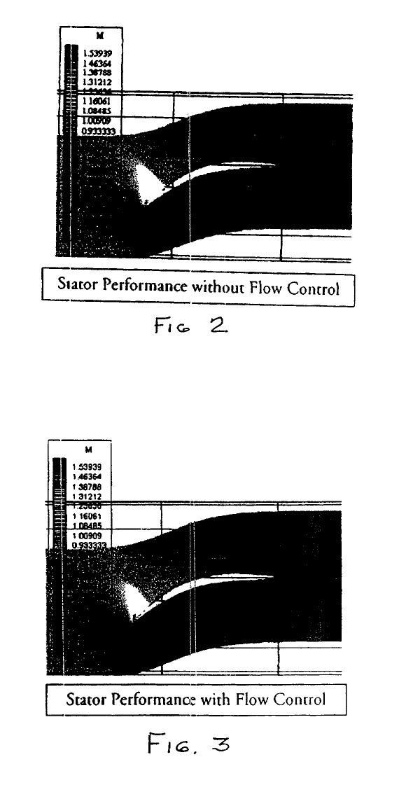

FIG. 2 is a graph showing the stator performance without the application of flow control,

FIG. 3 is a graph showing the stator performance with flow control technology,

FIG. 4 is a three dimensional view of flow control in the stator using ejector pumps,

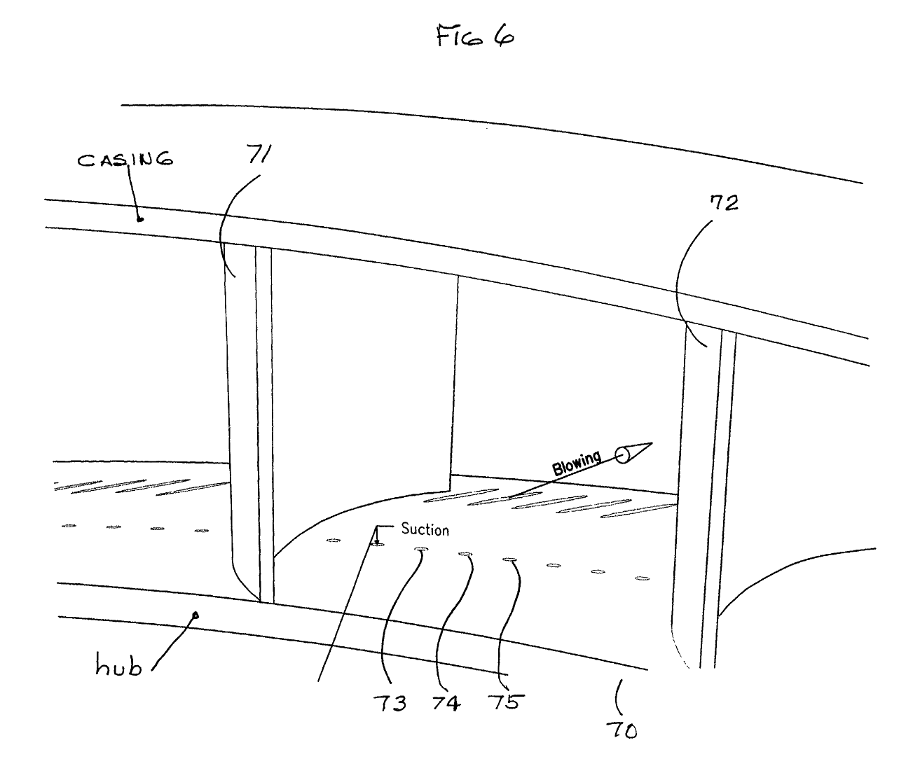

FIG. 5 is sequential depiction of the boundary layer as it is acted upon by the suction to prevent separation,

FIG. 6 is a three dimensional representation of the invention applied to maintaining flow control with ejector pumps for hub and casing in compressors,

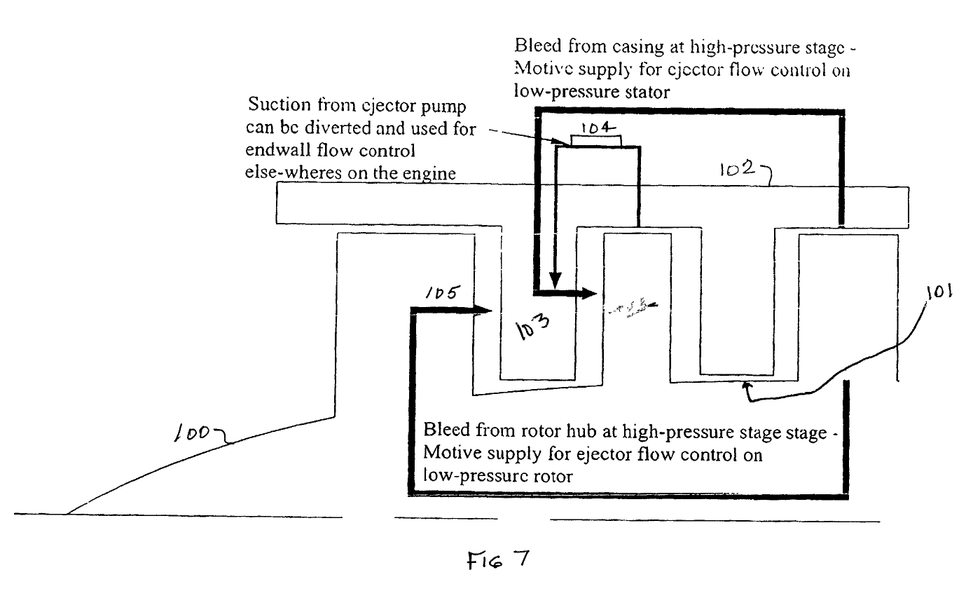

FIG. 7 is cross-sectional view of a stator rotor interaction using the invention to control boundary flow separation and ejector flow control on rotor, stator & casing. It also shows the suction does not have to be close coupled with blowing and can be piped elsewhere.

FIG. 8 is a table of nomenclature used to describe the invention.

FIG. 9 is a chart showing the relationship between inlet air mass flow and total pressure ratio R in a stage compressor,

FIG. 10 is a chart of effective total pressure distortion intensity at compressor entry plotted against surge pressure ratio loss,

FIG. 11 shows a plot of microphone signals in a transmitting boundary layer,

FIG. 12 is a plot of pressure fluctuations with varying amounts of suction.

FIG. 13 is a picture of inlet with suction and blowing plenums.

FIG. 14 is a table showing comparison between instant inlet and Balls inlet.

FIG. 15 is a table showing a comparison of Ball's inlet and the instant inlet.

FIG. 16 is a graph showing area distribution of the instant inlet.

FIG. 17 is a depiction of the blowing and suction hole geometry for the inlet.

FIG. 18 is a cross-sectional view of an ejector pump used in this invention.

FIG. 19 and FIG. 20 show placement of blowing and suction holes along with reference microphones in a BLC device.

FIG. 21 is a chart showing the improvement by using flow control

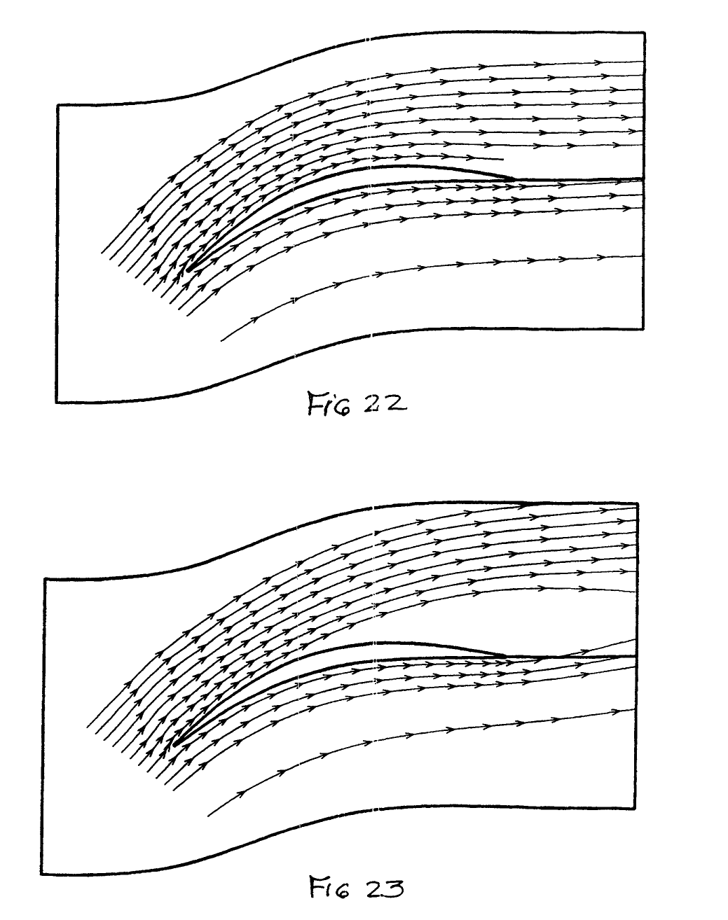

FIGS. 22 and 23 are simplified charts showing the flow of FIGS. 2 and 3 in more detail.

The tests showed that the benefits of boundary layer control in a compact, highly offset serpentine inlet were substantial. The compactness of the inlet allows an application to unmanned air vehicles (UAVs) that require a low radar cross section (RCS) but high performance and minimal weight. BLC was shown to improve the distortion and pressure recovery of the inlet by means of enhancing the total pressure at the exit with suction and blowing flowrates of around 1% of the core flow. The suction and blowing used together showed that the combination was better than either being used by itself The combination produced a decrease in distortion of 40.5% while the flow ratio increased by 9.66%. Optimized configurations will obviously do better than those used in the test. BLC allows the simulator to operate in a range where normally it wouldn't be able to operate. As the BLC minimized the deficit of the profile and improved the distortion and recovery, the magnitude of the microphone pressure decreased.

Referring now to FIG. 1 there is shown an inlet 11 connected to engine and exhaust 12. The intake casing bends around as at 13 to form a curved inner mouth 14 on which the control of the boundary layer is affected. A curved opening 15 curves down as at 16 into a scooped section 17 in which a suction tube 21 is located. The opening of tube 21 is adjacent the upper curved lip 18 of opening 15. A second opening lip 19 is located upstream from opening 15 and has a curved lip 20 which, with curved lip 19, provides for a smooth channeling effect. Likewise, curved lip 15 cooperates with lip 18 to provide a second smooth channel. Opening 22 of tube 21 is located in the latter channel. The scooped section shown is not essential but can be used to enhance the suction flow rate.

Referring now to FIG. 1B, there is shown jet tube 21 having an inner surface 25 which is tapered as at 26 and 27 to meet to produce an annular ring 28 which provides for a venturi effect when suction is applied to the tube. This is a special type of nozzle known as a converging/diverging nozzle that is necessary to produce a supersonic jet. While this type of nozzle can be used in the instant invention a conventional nozzle also shown in FIG. 1B as 30 having a smooth interior as at 31 is also used to produce less than supersonic flow. This jet nozzle combined with the plenum constitutes an ejector pump which is used to produce suction to the area to affect BLC. FIG. 1A shows a generic pump which has a vacuum created at its suction hole and due to the constricting of the flow channel the pressure in the narrow part of the pump is increased and high-pressure air is introduced via the jet nozzle to mix with the air entering from the inlet to finally exit as a mixed flow from the end of the pump.

The ejector pump acts to create a vaccum in the plenum chamber defined by the mixed air and flow rushing out of the end of tube 21 and exiting in the form of an almost tangential blowing through the hole defined by tapered area 27 and adjacent opening 15 into casing 1. This creates, in the plenum chamber 17, a vacuum producing suction to be applied to the area of the entrance to the serpentine inlet to the engine 10. The smooth area 20 and lip 19 define a second entrance to the plenum chamber which causes suction to the flow coming in the inlet mouth 14.

FIGS. 2 and 3 show the result of the stator performance of engine 10 with and without flow control as described in this invention.

FIG. 4 shows a series of flow control apertures in the leading edge of a airfoil such as 50. The edge has a parallel series of holes such as 51 and 52 therein which, referring to FIG. 5 show the first holes as producing suction into a plenum chamber 53 which is connected, via nozzle 54, to a source of high pressure air such as 55. In effect, the source and nozzle 54 act as an ejector pump to produce both suction and blowing along the surface 50 of the airfoil. The jet produced by nozzle 54 entrains air as it passes through plenum 53 creating suction at hold 51. FIG. 5 shows the boundary layer approaching separation as at “A”, having been further adhered by the suction as at “B” and finally being energized as at “C” by the blowing out of 52. As can be seen by the charts of FIGS. 2 and 3, the flow control greatly enhances the performance of the stator as shown in the blue area in FIG. 3 when contrasted with the same blue area in FIG. 2. This phenomena is more adequately described at the end of this specification in the discussion of FIGS. 22 and 23.

The spinning nature of the rotors in an axial compressor act to not only compress the air but also cause it to swirl about the axis of a compressor. The job of the stators is to turn the flow back in the axial direction and convert some of the kinetic energy generated by the rotors into pressure. The objective of this invention is to create stators that turn the flow more aggressively (highly loaded stators) and create a higher-pressure rise. This tends to create a separation prone stator. The flow control invention is designed to prevent this separation.

FIG. 6 shows application of the use of the ejector pumps for hub and casing flow control in compressors. There is shown a main hub 70 with stators 71, 72 and a main lower surface 73 in which are located a series of suction holes 74 and blowing holes 75. As the hub and casing house the stator, the same principles are used to control boundary layer effects. Flow control could be in the hub or casing although only flow control on the hub is shown.

FIG. 7 shows the use of the ejector pump flow control invention in an application for combined use in both rotors and stators and casing. There is shown a general engine 100 which has a rotor hub 101 and a casing 102 . The bleed from the casing 102 at high-pressure stage is the motive supply for ejector pump flow control on the low-pressure stator 103. The suction from the ejector pump 104 can be diverted and used for endwall flow control elsewhere on the engine. Also, a bleed from the rotor hub at high-pressure stage is the motive supply for ejector flow control on the low pressure rotor as at 105.

FIG. 8 is a chart of the nomenclature used in this specification including reference to the formula.

FIG. 9 is a graph showing the effect of distortion on a compressor map. Note how the surge margin decreases as the level of circumferential distortion increases. Note also that when the distortion goes above the critical angle of 90 degrees, the surge line changes very little. The figure also shows that a loss of efficiency is created by distortion. FIG. 10 reiterates the effect that distortion intensity has in losing surge pressure ratio, it shows the ratios sensitivity to distortion.

FIG. 11 shows the microphone signals in a transitioning boundary layer. It shows the development of turbulent spots that spread into a full-blown turbulent boundary layer as the distance from the leading edge is increased. Each microphone signal was conditioned and then sent to a controller for the centrifugal pump to control the suction flowrate. FIG. 11 shows pressure fluctuations with varying amounts of suction. It shows the root-mean-square (rms) pressure decreases as the suction flowrate increases. It also shows that as the boundary layer grows from the leading edge, the microphone sees a higher rms pressure.

FIG. 13 shows the inlet constructed to perform the tests needed to prove the invention would function as predicted. It is made of Plexiglas with a suction plenum and a blowing plenum. A bellmouth was used as it was short. FIG. 14 compare the two dimensional inlet of Ball with the one used to perfect this invention. Ball's inlet was scaled down and then shortened. This is important as it was desirable to show that this invention performs for shorter inlets which usually cause stalling at lower Mach speeds. FIG. 15 shows the reduced size of the instant inlet used. FIG. 16 shows area distribution of the inlet used in the invention.

The design and placement of the suction and blowing holes is shown in FIG. 17 which also has a table accompanying it. The figure shows the relationship between the suction plenum and blowing plenums as well.

FIG. 18 shows a typical cross section of an ejector pump. The ones used are those known as Vaccon VDF model ejector pumps which are very robust. Specifically the VDF-375 model was used in a modified manner and the air pressure regulated to 90 psig.

FIGS. 19 and 20 show, respectively, the bottom surface of the inlet with one array of ten microphones and the other the bottom surface of the inlet with two sets of three microphones installed.

Experiments were performed in a transonic cascade windtunnel. The model had 6″ spans and 4″ chord lengths. Design conditions were Mach 0.8 and an incidence angle of 3degrees. Data was taken by employing a Pitot probe traversed downstream of the stators. The results operating at design flow and using 1% of the core flow for flow control were a 48% reduction in the stator loss coefficient and a 4.5 degree increase in turning.

FIG. 21 shows a graph illustrating the advantages of flow control in minimizing the losses behind the stator. It shows experimental data from the flow control stator. The dip in each plot represents losses behind the stator. With flow control, the dip is considerably smaller. Technically ,the dip is referred to as the “wake” or or total pressure deficit. Note that the dip has shifted which indicates the increase in turning.

FIGS. 22 and 23 are simplified versions of FIGS. 2 and 3 and show streamlines and velocity profiles over the stator with and without flow control. The color shading represents velocity. The scale is to the left and is given as the local Mach number. The very low velocity area on the backside of the stator is the wake. This area is very much smaller with flow control. The plots show the streamlines separating from the surface of the stator and generating a large wake and the difference in exit flow angle.

While a few preferred embodiments have been shown and described, it will be obvious to those of ordinary skill in the art that many changes and modifications can and will be made without departing from the scope of the appended claims.

1 a boundary layer flow control mechanism for use in diffusors, aircraft wings, propellers, rotors, stators, casings, automobiles and water craft, said mechanism comprising,
a suction means for applying a suction to a flow,
a blowing means for applying blowing to a flow in a manner to cause said suction means to apply suction,
control means connecting said suction and blowing means so that they act in concert to affect boundary layer control to said flow:

2. A boundary layer flow control mechanism as in claim 1 wherein said suction means and blowing means are connected by means of a plenum chamber and said control means acts upon said plenum chamber to affect boundary layer control.

3. A boundary layer flow control mechanism as in claim 1 wherein said suction means and said blowing means comprise an ejector pump for introducing pressurized air onto the flow.

4. A mechanism as in claim 1 wherein said blowing means provides blowing in such a way as to produce a suction for said suction means through an interconnected passageway.

5. A boundary layer flow control mechanism as in claim 4 and wherein said blowing means and said suctions means comprise an ejector pump for introducing said pressurized air to said flow.

6. A boundary layer flow control mechanism as in claim 5 and including a plenum chamber means connecting said suction means and blowing means, said plenum chamber means receiving both the air from said suction means and the pressurized air from said ejector pump and propelling the mixture out said blowing means to effect adhesion of the boundary layer of the flow.

7. A boundary layer flow control mechanism as in claim 1 wherein said blowing means provides suction for said suction means.

8. A boundary layer flow control mechanism as in claim 7 wherein said suction means and said blowing means comprise said ejector pump which also includes said plenum chamber.

9. A boundary layer flow control mechanism as in claim 8 wherein said ejector pump delivers a stream of pressured air via said plenum chamber which mixes with the air coming in said suction means and is forced out said blowing means to effect adhesion of said boundary layer.

10. A boundary layer flow mechanism as in claim 1 wherein said blowing means is downstream of said suction means.

11. A boundary layer flow mechanism as in claim 10 wherein said blowing means is upstream of said suction means.

12. A boundary layer adhesion system for maintaining adhesion of turbulent flow on a flow surface, said system comprising
a suction means in said flow surface for pulling flow air from said surface,
a blowing means in said flow surface downstream of said suction means for ejecting a mixtuure of air from said suction means and pressurized air and for producing said suction at said suction means,
control means including a source of pressurized air for introducing said pressurized air to mix with said suction air for controlling the boundary layer adhesion of the flow.

13. A boundary layer adhesion system as in claim 12, further
including a plenum chamber where the suction air and the pressurized air are mixed to be ejected by said blowing means to effect adhesion of said flow on a flow surface.

14. A boundary layer adhesion system as in claim 13 wherein said chamber, suction Means and said blowing means comprise an ejector pump having a plenum chamber.

15. A boundary layer adhesion system having a suction means for pulling air from a flow on a flow surface and a source of pressurized air and pump means for first creating said suction and then mixing said pressurized air with the air pulled by said suction means and blowing it onto said flow surface to effect adhesion of said flow.

16. A boundary layer adhesion system as in claim 15 wherein said pump means and said blowing and suction means comprises an ejector pump.

17. A boundary layer adhesion system as in claim 16 wherein said pump means is adapted to blow said mix of suction pulled air and pressurized air almost tangentially along said flow surface.

18. A boundary layer adhesion system as in claim 17 wherein said means for pulling flow air is upstream of the pump means blowing said mixture of airs onto the flow surface.

19. The method of effecting adhesion of flow on in a boundary layer effect environment having a flow surface comprising
blowing air along a tangential surface, said blowing causing suction to occur,
sucking air from a flow along said flow surface by the suction created by blowing air along said tangential surface,
mixing said sucked air with pressurized air and blowing said mixture of sucked air and pressurized air onto said flow surface downstream of where the sucking of air occurs.

20. The method of claim 19 and including blowing said mixed air in a direction almost tangential to the flow surface so as to effect adhesion of said flow.
